(19) United States
(12) Patent Application Publication
(10) Pub. No.: US 2026/0044099 A1
(43) Pub. Date: Feb. 12, 2026

(54) IMAGE FORMING APPARATUS

(71) Applicant: CANON KABUSHIKI KAISHA, Tokyo (JP)

(72) Inventors: TOMOHIRO HASEGAWA, Chiba (JP); NAOKI KAMADA, Chiba (JP)

(21) Appl. No.: 19/235,921

(22) Filed: Jun. 12, 2025

(30) Foreign Application Priority Data
Aug. 6, 2024 (JP) 2024-129689

(51) Int. Cl. G03G 15/20; G03G 15/00

(52) U.S. Cl. CPC G03G 15/205; G03G 15/2064; G03G 15/5012; G03G 15/5016; G03G 2215/00413; G03G 2215/00776

(57) ABSTRACT

An image forming apparatus includes a fixing unit, a detector detecting inside temperature and humidity. The apparatus executes a continuous image forming job in which first and second recording materials of first and second basis weights are mixedly included, in a first mode in which a fixing temperature of the fixing unit is set to a first temperature in a case of the first basis weight and is set to a second temperature lower than the first temperature in a case of the second basis weight smaller than the first basis weight, and in a second mode in which the setting temperature is set to a common temperature irrespective of the basis weight. A display displays that the second mode cannot be applied to the job in a case where both the inside temperature and humidity are not within a predetermined range when the second mode has been input.

### BACKGROUND

### Field of Technology

The present invention relates to an image forming apparatus such as a copy machine, a printer and a facsimile machine, and a multifunction machine provided with a plurality of functions of these.

### Description of the Related Art

An image forming apparatus is provided with a fixing device which fixes a toner image onto a recording material by applying heat and pressure to the recording material while nipping and conveying the recording material on which a toner image has been formed. The fixing device includes a rotatable heating member for heating the recording material and a rotatable pressing member which presses the rotatable heating member to form a fixing nip which nips and conveys the recording material to apply the heat and the pressure. Since an amount of heat required to fix the toner image is different depending on a basis weight of the recording material, a setting temperature (referred to as a fixing temperature) of the rotatable heating member is adjustable corresponding to the basis weight of the recording material in the fixing device.

However, upon switching the fixing temperature, a print operation of the image forming apparatus may be suspended, and by performing the suspension, productivity of the recording material is decreased. Therefore, in Japanese Patent Application Laid-Open No. 2005-321478, it is proposed that in a case in which a continuous image forming job in which the toner images are continuously formed on a plurality of the recording material, in which the recording material having different fixing temperatures are mixedly included, (referred to as a mixed job) is executed, by using a common temperature for those recording material before starting the mixed job, a number of times of the suspension is reduced and the decrease in the productivity of the recording material is suppressed.

### SUMMARY

According to an aspect of the present invention, there is provided an image forming apparatus comprising: an image forming unit configured to form a toner image on a recording material; a fixing unit including a first rotatable member and a second rotatable member which forms a fixing nip for nipping and conveying the recording material by contacting the first rotatable member, and configured to fix the toner image onto the recording material by applying heat and pressure on the recording material on which the toner image is formed; an executing portion configured to be capable of executing a continuous image forming job in which a first recording material of a first basis weight and a second recording material of a second basis weight are mixedly included, in either one of an operating mode of a first mode in which a fixing temperature which is a setting temperature of the first rotatable member is set to a first temperature in a case in which a basis weight of the recording material is the first basis weight and the setting temperature is set to a second temperature lower than the first temperature in a case in which the basis weight of the recording material is the second basis weight smaller than the first basis weight, and a second mode in which the setting temperature is set to a common temperature irrespective of the basis weight of the recording material; an input portion configured to be capable of inputting either one of the operating mode of the first mode and the second mode; a detecting portion configured to detect an inside temperature and an inside humidity in the image forming apparatus; and a display portion configure to display that the second mode cannot be applied to the continuous image forming job in a case in which a condition that both the inside temperature and the inside humidity detected by the detecting portion are within a predetermined range is not satisfied when the second mode has been input to the input portion.

Further features of the present invention will become apparent from the following description of exemplary embodiments with reference to the attached drawings.

### BRIEF DESCRIPTION OF THE DRAWINGS

FIG. 1 is an outline view illustrating an image forming system.

FIG. 2 is a block diagram illustrating a system configuration.

FIG. 3 is an outline view illustrating an image forming apparatus in an Embodiment 1.

FIG. 4 is an outline view illustrating a fixing device.

FIG. 5 includes temperature tables showing fixing temperatures corresponding to basis weights of recording material, and part (a) is a balanced temperature control mode for high speed, part (b) is a balanced temperature control mode for low speed, and part (c) is an image quality prioritized temperature control mode.

FIG. 6 includes part (a), which is a view showing an initial screen, part (b), which is a view showing a selection screen for an advanced mode, and part (c), which is a view showing a selection screen for speed/image quality priority adjustment.

FIG. 7 includes views for describing a mixed productivity prioritized mode, and part (a) shows a case in which a print order condition is satisfied and part (b) shows a Conventional Example.

FIG. 8 is a flowchart showing a process during standby.

FIG. 9 is a flowchart showing an applicability determination process.

FIG. 10 is a view illustrating a notification screen displayed during standby.

FIG. 11 is a flowchart showing a process during job start in the Embodiment 1.

FIG. 12 includes part (a), which is a view illustrating an operation setting screen, and part (b), which is a view illustrating a notification screen displayed during job start in the Embodiment 1.

FIG. 13 is a flowchart showing a process during job execution in the Embodiment 1.

FIG. 14 is a flowchart showing a process during job start in an Embodiment 2.

FIG. 15 is a view illustrating a forcible application selection screen displayed during job start.

FIG. 16 is a flowchart showing a part of a process during job execution in the Embodiment 2.

FIG. 17 is a flowchart showing a part of the process during job execution in the Embodiment 2.

FIG. 18 is a view illustrating a forcible application selection screen displayed during job execution

### DESCRIPTION OF THE EMBODIMENTS

### Embodiment 1

### <Image Forming System>

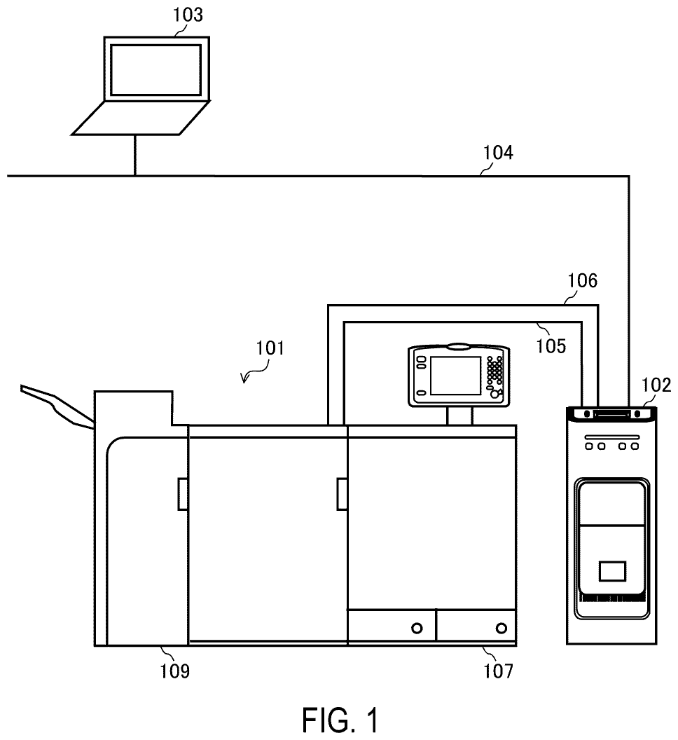

FIG. 1 is a configuration view of an image processing system which includes an image forming apparatus 101 in the present Embodiment. The image processing system is provided with the image forming apparatus 101 and an external controller 102. The image forming apparatus 101 is, for example, a multifunction machine, a multifunction peripheral (MFP), etc. The external controller 102 is, for example, an image processing controller, a digital front end (DFE), a print server, etc.

The image forming apparatus 101 and the external controller 102 are communicably connected via an internal LAN (Local Area Network) 105 and a video cable 106. The external controller 102 is connected to a client PC (Personal Computer) 103 via an external LAN 104. The external controller 102 acquires a print instruction (an image forming job) from the client PC 103.

To the client PC 103, a printer driver, which has a function for converting image data into a print description language which can be processed by the external controller 102, is installed. A user can instruct a print via the printer driver through various types of applications. The printer driver sends the image data to the external controller 102 based on the image forming job. The external controller 102 receives the image forming job which includes the image data from the client PC 103, performs a data analysis and a rasterizing processing, and instructs the print (image formation) to the image forming apparatus 101 based on the image data.

The image forming apparatus 101 is constituted by a plurality of devices having different functions, which includes a printing device 107, being connected thereto, and is capable of a complex print process such as a bookbinding. The image forming apparatus 101 in the present Embodiment is provided with the printing device 107 and a finisher 109. The printing device 107 forms an image using developer (for example, toner) to a recording material fed from a sheet feeding portion, which is provided to a lower portion of a main assembly thereof. The printing device 107 forms images of yellow (Y), magenta (M), cyan (C) and black (K). Onto the recording material, a full-color image in which the images of each color are superimposed is formed. The recording material on which the image has been formed is conveyed from the printing device 107 to the finisher 109. The finisher 109 stacks the recording material on which the image has been formed.

This image processing system has a configuration in which the external controller 102 is connected to the image forming apparatus 101, however, the external controller 102 is not necessary. For example, it may be a configuration in which the image forming apparatus 101 acquires the image forming job which includes the image data directly from the client PC 103 via the external LAN 104. In this case, the image forming apparatus 101 performs the data analysis and the rasterizing processing, which is performed by the external controller 102. In other words, it may be configured integrally with the image forming apparatus 101 and the external controller 102.

### <System Configuration>

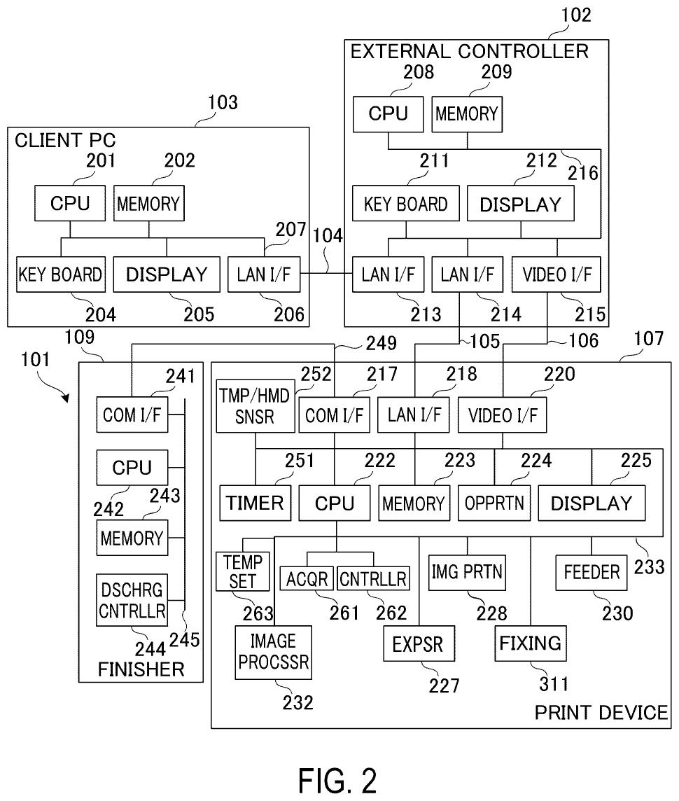

FIG. 2 is a system configuration view which controls an operation of the image processing system. Here, for each of the image forming apparatus 101, the external controller 102, the client PC 103 and the printing device 107, controllers which control operations thereof will be described.

### <Printing Device>

The printing device 107 is, to communicate with other devices, provided with a communication interface (I/F) 217, a LAN I/F 218 and a video I/F 220. The printing device 107 is provided with a CPU (Central Processing Unit) 222, a memory 223, and an image processing portion 232 to control the operation of the printing device 107. The printing device 107 is provided with an exposure portion 227, an image forming portion 228, a fixing device 311 and a sheet feeding portion 230 for forming the image. The printing device 107 is provided with an operating portion 224 and a display 225 (for example, a touch panel) as a user interface. The printing device 107 is provided with a timer 251 and a temperature and humidity sensor 252 for adjusting a correcting value for optimally correcting geometric properties of the images for front and back surfaces of the recording material. Here, the geometric properties of the image are, for example, a squareness and a printing position of the image relative to the recording material. These constituting components are communicably connected to each other via a system bus 233.

A communication I/F 217 is connected to the finisher 109 via a communication cable 249 and controls communication to and from the finisher 109. In a case in which the printing device 107 and the finisher 109 are operated cooperatively, information and data are sent and received via the communication I/F 217. The LAN I/F 218 is connected to the external controller 102 via the internal LAN 105 and controls communication to and from the external controller 102. The printing device 107 receives print settings from the external controller 102 via the LAN I/F 218. The video I/F 220 is connected to the external controller 102 via the video cable 106 and controls communication to and from the external controller 102. The printing device 107 receives the image data representing the image to be formed from the external controller 102 via the video I/F 220.

The CPU 222 as an executing portion collectively performs image processing and control of the printing by executing computer programs stored in the memory 223. The memory 223 provides a work area upon the CPU 222 executing various types of processing. In a case of performing an image forming process, the CPU 222 is capable of controlling the exposure portion 227, the image forming portion 228, the fixing device 311 and the sheet feeding portion 230.

The exposure portion 227 is provided with a photosensitive member, a charging wire which charges the photosensitive member, and a light source which exposes the photosensitive member charged by the charging wire to form an electrostatic latent image on the photosensitive member. Incidentally, the photosensitive member is, for example, a photosensitive belt, in which a photosensitive layer is formed on a surface of an elastic member which has a belt shape, or a photosensitive drum, in which a photosensitive layer is formed on a surface of a cylinder. In addition, instead of the charging wire, a charging roller may be used. The exposure portion 227 charges the surface of the photosensitive member to uniform negative potential by the charging wire. The exposure portion 227 outputs a laser light based on the image data from the light source. The laser light scans the uniformly charged surface of the photosensitive member. As a result, in the photosensitive member, potential of positions irradiated by the laser light is changed, and the electrostatic latent image is formed on the surface thereof. Four photosensitive members are provided corresponding to the four colors of yellow (Y), magenta (M), cyan (C) and black (K). The electrostatic latent images corresponding to different color images are formed on the four photosensitive members, respectively.

The image forming portion 228 as an image forming unit transfers a toner image formed on the photosensitive member to the recording material. The image forming portion 228 is provided with a developing unit, a transfer unit and a toner supply portion. The developing unit forms the toner image by making toner, which is charged to negatively polarity, adhered from a developing cylinder to the electrostatic latent image formed on the surface of the photosensitive member. Four developing units are provided corresponding to the four colors of yellow (Y), magenta (M), cyan (C) and black (K). The developing unit visualizes the electrostatic latent image on the photosensitive member with the toner of the corresponding color.

The transfer unit includes an intermediary transfer belt 308, and transfers the toner image from the photosensitive member to the intermediary transfer belt 308. At a position opposing to the photosensitive member across the intermediary transfer belt 308, a primary transfer roller is provided. By positive potential being applied to the primary transfer rollers, the toner images are transferred and superimposed onto the intermediary transfer belt 308 from each of the four photosensitive members. As a result, a full-color toner image is formed on the intermediary transfer belt 308. The toner image formed on the intermediary transfer belt 308 is transferred to the recording material by a secondary transfer roller, which will be described below. The secondary transfer roller transfers, by positive potential being applied thereto, the full-color toner image from the intermediary transfer belt 308 to the recording material.

The fixing device 311 as a fixing unit fixes the transferred toner image to the recording material. The fixing device 311 includes a heater and a roller pair. The fixing device 311, by applying heat and pressure to the toner image on the recording material with the heater and the roller pair, melts and makes the toner image fixedly adhered onto the recording material. As a result, a product in which the image has been formed on the recording material is produced. The sheet feeding portion 230 is provided with a conveyance roller and various types of sensors in a conveyance path and controls a feeding operation of the recording material.

The operating portion 224 as an input portion is an input device which receives input of various types of settings and an instruction for an operation from a user, and is, for example, various types of input keys and/or a touch panel. The display 225 as a display portion is an output device which displays setting information of the image forming apparatus 101 and a processing status (status information) of the image forming job. In the present Embodiment, the operating portion 224 is capable of inputting, for example, a start instruction and an operating mode for a mixed job. The mixed job is a continuous image forming job, which forms the images on a plurality of the recording material having different basis weights and in which a first recording material of a first basis weight and a second recording material of a second basis weight smaller than the first basis weight are mixedly included.

The timer 251 counts time. The CPU 222 acquires a current date and time based on a count value of the timer 251. The temperature and humidity sensor 252 as a detecting portion detects an inside temperature and an inside humidity in the image forming apparatus 101 (in more detail, in the printing device 107). The CPU 222 acquires, based on a detection result of the temperature and humidity sensor 252, the inside temperature and the inside humidity as an environment condition. A temperature setting portion 263 performs setting of a fixing temperature corresponding to the basis weight of the recording material. The CPU 222 may change a temperature of a fixing belt 401 of the fixing device 311 based on the fixing temperature set by the temperature setting portion 263.

### <Finisher>

The finisher 109 executes a stapling processing to the products output from the printing device 107, for example. The finisher 109 is provided with a communication I/F 241, a CPU 242, a memory 243 and a sheet discharge control portion 244. These constituting components are communicably connected to each other via a system bus 245. The communication I/F 241 is connected to the printing device 107 via the communication cable 249 and controls the communication to and from the printing device 107. In the case in which the finisher 109 and the printing device 107 are operated cooperatively, the information and the data are sent and received via the communication I/F 241. The CPU 242 executes control programs stored in the memory 243 and performs various types of control necessary for sheet discharge. The memory 243 stores the control programs. In addition, the memory 243 provides a work area upon the CPU 242 executing various types of processing. The sheet discharge control portion 244 discharges, based on an instruction from the CPU 242, the conveyed recording material.

### <External Controller>

The external controller 102 is, to communicate with other devices, provided with a LAN I/F 213, a LAN I/F 214 and a video I/F 215. The external controller 102 is, to control operation of the external controller 102, provided with a CPU 208 and a memory 209. The external controller 102 is provided with a keyboard 211 and a display 212 as user interfaces. These constituting components are communicably connected to each other via a system bus 216.

The LAN I/F 213 is connected to the client PC 103 via the external LAN 104 and controls communication to and from the client PC 103. The external controller 102 acquires the image forming job from the client PC 103 through the LAN I/F 213. The LAN I/F 214 is connected to the printing device 107 via the internal LAN 105 and controls the communication to and from the printing device 107. The external controller 102 sends the print settings to the printing device 107 via the LAN I/F 214. The video I/F 215 is connected to the printing device 107 via the video cable 106 and controls the communication to and from the printing device 107. The external controller 102 sends the image data to the printing device 107 via the video I/F 215.

The CPU 208 collectively performs, by executing computer programs stored in the memory 209, processing such as receiving of the image data sent from the client PC 103, an RIP (Raster Image Processor) processing and sending of the image data to the image forming apparatus 101. The memory 209 provides a work area upon the CPU 208 executing the various types of processing. The keyboard 211 is an input device which receives input of various types of settings and an instruction for an operation from a user. The display 212 is an output device which displays information on an executed application by the external controller 102 in a form of a still image and/or a moving image.

### <Client PC>

The client PC 103 is provided with a CPU 201, a memory 202, a keyboard 204, a display 205 and a LAN I/F 206. These constituting components are communicably connected to each other via a system bus 207.

The CPU 201 controls, by executing computer programs stored in the memory 202, an operation of the client PC 103. In the present Embodiment, the CPU 201 performs generating of the image data and sending process of the image forming job. The memory 202 provides a work area upon the CPU 201 executing the various types of processing. The keyboard 204 and the display 205 are user interfaces. The keyboard 204 is an input device which receives an instruction from a user. The display 205 is an output device which displays information on an executed application by the client PC 103 in a form of a still image and/or a moving image. The LAN I/F 206 is connected to the external controller 102 via the external LAN 104 and controls the communication to and from the external controller 102. The client PC 103 sends the image forming job which includes the image data to the external controller 102 through the LAN I/F 206.

Incidentally, the external controller 102 and the image forming apparatus 101 are connected to each other by the internal LAN 105 and the video cable 106 in the present Embodiment, however, it is sufficient for the configuration to be capable of sending and receiving data required for the printing, for example, and the external controller 102 and the image forming apparatus 101 may be connected only by the video cable 106. It is sufficient for the memory 202, the memory 209, the memory 223 and the memory 243 to be storage devices for storing data and programs, respectively. For these memories, for example, a volatile RAM (Random Access Memory), a nonvolatile ROM (Read Only Memory), a storage, a USB (Universal Serial Bus) memory, etc. can be used.

### <Configuration of the Image Forming Apparatus>

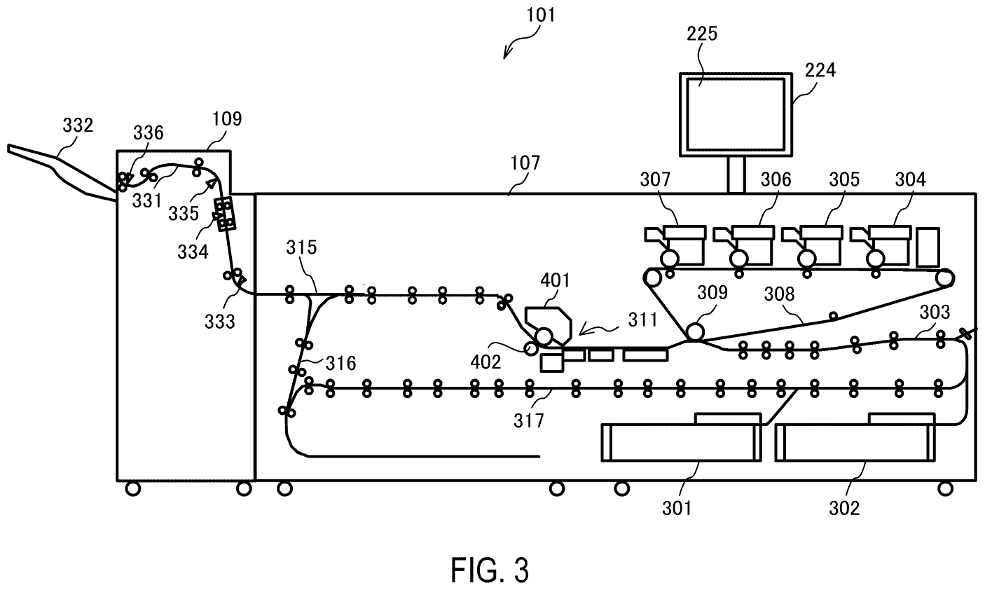

FIG. 3 is a configuration view of the image forming apparatus 101. In an upper portion of the printing device 107, the operating portion 224, which includes the display 225, is provided. The display 225 displays a printing status and information for a setting of the image forming apparatus 101. The recording material (product) on which the image has been formed in the printing device 107 is conveyed to the finisher 109, which is provided at a latter step.

The printing device 107 is provided with a plurality of sheet feeding decks 301 and 302, and a conveyance path 303 as the sheet feeding portion 230. In each feeding deck 301 and 302, different types of the recording material can be accommodated. Information on the accommodated recording material (basis weight, a type of the recording material, etc.) is detectable on the device side, and in the present Embodiment, it is configured to be settable by a user through the operating portion 224.

An uppermost sheet of the recording material accommodated in each feeding deck 301 and 302 is separated and fed into the conveyance path 303. The printing device 107 is provided with, as the exposure portions 227, image forming portions 304, 305, 306 and 307 for forming the image. The printing device 107 forms the color image. For that purpose, the image forming portion 304 forms a black (K) image (toner image). The image forming portion 305 forms a cyan (C) image (toner image). The image forming portion 306 forms a magenta (M) image (toner image). The image forming portion 307 forms a yellow (Y) image (toner image).

The printing device 107 is provided with, as the image forming portion 228, the intermediary transfer belt 308, to which the toner images are transferred from each image forming portion 304, 305, 306 and 307, and a secondary transfer roller 309. The intermediary transfer belt 308 is rotated clockwise in the figure, and the toner images are transferred and superimposed in an order of the image formation portion 307, the image forming portion 306, the image forming portion 305 and the image forming portion 304. As a result, the full-color toner image is formed on the intermediary transfer belt 308. The intermediary transfer belt 308 conveys, by being rotated, the toner image to the secondary transfer roller 309. The recording material is conveyed to the secondary transfer roller 309 in synchronization with a timing when the toner image is conveyed to the secondary transfer roller 309. The secondary transfer roller 309 transfers the toner image on the intermediary transfer belt 308 onto the conveyed recording material.

The printing device 107 is provided with the fixing device 311. The fixing device 311 includes the fixing belt 401 and a pressing roller 402 to fix the toner image onto the recording material. To the recording material, by passing through a fixing nip formed by the fixing belt 401 and the pressing roller 402, the heat and the pressure are applied. As a result, the toner image is melted, pressed and adhered to a first surface of the recording material.

The recording material which has passed through the fixing device 311 is guided to a conveyance path 315. In a case in which a double-side printing is instructed, the image is formed also on a back surface (second surface) of the recording material. Therefore, the recording material is guided to a reversing path 316. The recording material conveyed to the reversing path 316 is reversed in a conveyance direction in the reversing path 316 and conveyed to a double-side conveyance path 317. By the reversing path 316 and the double-side conveyance path 317, the front surface and the back surface of the recording material is reversed by a switchback conveyance. The recording material is conveyed to the conveyance path 303 by the double-side conveyance path 317, and by passing through the secondary transfer roller 309 and the fixing device 311, the image is formed on the second surface different from the first surface.

In a case of a single-side printing, or in the case in which the images are formed on both sides in the double-side printing, the recording material is conveyed to the conveyance path 315 and handed to the finisher 109. The finisher 109 can stack the recording material handed from the printing device 107. The finisher 109 is provided with a conveyance path 331 and a stacking tray 332 for stacking the recording material. In the conveyance path 331, conveyance sensors 333, 334, 335 and 336 are provided. The recording material conveyed from the printing device 107 is, via the conveyance path 331, stacked on the stacking tray 332. The conveyance sensors 333, 334, 335 and 336 detect passing of the recording material conveyed through the conveyance path 331. The CPU 242 determines, if a leading end or a trailing end in a conveyance direction of the recording material is not detected by the conveyance sensors 333, 334, 335 and 336 even after a predetermined time elapses from the conveyance of the recording material in the finisher 109 being started, that a conveyance jam (conveyance abnormality) has occurred in the finisher 109. In this case, the CPU 242 notifies the printing device 107 that the conveyance jam has occurred.

### <Fixing Device>

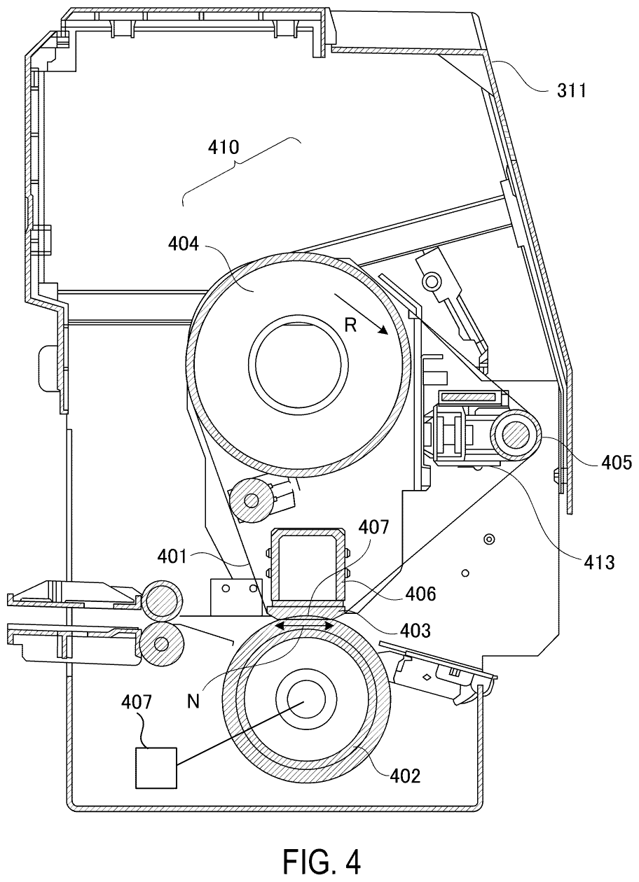

Next, using FIG. 4, detail of a configuration of the fixing device in the present Embodiment will be described. FIG. 4 is a cross-sectional view of the fixing device in the present Embodiment. In FIG. 4, the recording material is conveyed from right to left direction on paper. The fixing device 311 includes a heating unit 410, which includes a heat source, and the pressing roller 402, which forms the fixing nip N together with the heating unit 410. The heating unit 410 includes the fixing belt 401 as a first rotatable member, which is endless and rotatable, a pad member (hereinafter, pad) 403, a heating roller 404 and a steering roller 405.

The heating roller 404, inside which an unshown halogen heater is disposed, is capable of generating heat to a predetermined temperature. The fixing belt 401 is heated by the heating roller 404, and based on temperature detection by an unshown thermistor, is controlled to be at the fixing temperature corresponding to the basis weight of the recording material. The thermistor may be in a mode of detecting a surface temperature of the heating roller 404, or in a mode of detecting a surface temperature of the fixing belt 401. The pressing roller 402 as a second rotatable member is a roller in which an elasticity layer is formed on an outer periphery of a shaft thereof and a release layer is formed on an outer periphery thereof. Here, the pressing roller 402 is rotationally driven by a motor 407, and the fixing belt 401, which is contacted by the pressing roller 402, is followingly rotated. When the recording material carrying an unfixed toner image is nipped and conveyed by the pressing roller 402 and the fixing belt 401 in the fixing nip N, the heat and the pressure which are necessary for the fixing are applied thereto. As a result, the toner image is fixed onto the recording material. Incidentally, the motor 407 may rotate at least one of the fixing belt 401 and the pressing roller 402.

### <Relationship Between the Basis Weight and a Conveyance Speed>

The image forming apparatus 101 in the present Embodiment can convey the recording material at a plurality of speeds, as a conveyance speed at which the record material is conveyed in the fixing nip N, which includes a first speed and a second speed. In a case of the present Embodiment, the first speed is a high conveyance speed of “600 mm/s”, and the second speed is a low conveyance speed of “400 mm/s” slower than the first speed. Although two speeds are described here as examples, the recording material may be conveyed at three or more speeds.

A reason why the recording material in the present Embodiment is conveyed at the plurality of the conveyance speeds will be described. The larger the basis weight of the recording material, the larger an amount of the heat required to fix the toner image. The faster the conveyance speed of the recording material, the less time in which the heat can be given to the recording material in the fixing nip N. Therefore, in a case in which the recording material having a large basis weight is continuously conveyed at a high speed, fixing performance may not be guaranteed. Therefore, in order to guarantee the fixing performance for the recording material having a large basis weight, it is necessary to have a low conveyance speed in addition to the high conveyance speed.

### <Temperature Table>

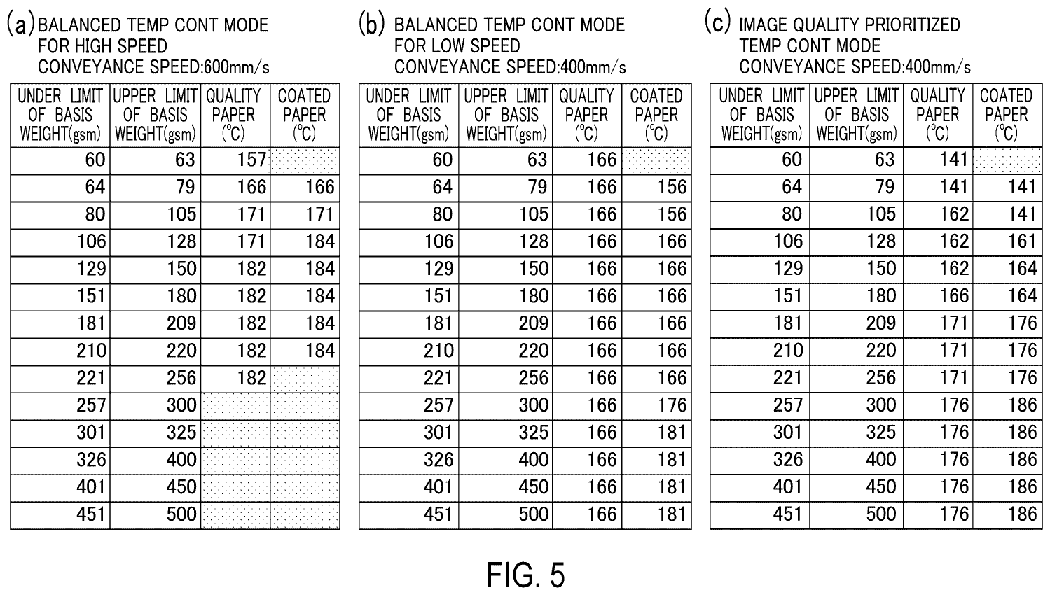

Part (a) of FIG. 5 through part (c) of FIG. 5 are temperature tables showing applicable fixing temperatures at the two kinds of the conveyance speeds described above. Part (a) of FIG. 5 shows a temperature table for a balanced temperature control mode for the high speed (conveyance speed of 600 mm/s), part (b) of FIG. 5 shows a temperature table for a balanced temperature control mode for the low speed (conveyance speed of 400 mm/s), and part (c) of FIG. 5 shows a temperature table for an image quality prioritized temperature control mode (conveyance speed of 400 mm/s). These temperature tables are stored in the memory 223 (see FIG. 2) in advance. In each temperature table, the fixing temperature corresponding to the basis weight of the recording material is set for each type of the recording material (here, a high quality paper and a coated paper).

However, as shown in part (a) of FIG. 5, in the temperature table for the balanced temperature control mode for the high speed, depending on the types of the recording material, the fixing temperature corresponding to the basis weight more than a predetermined value of the recording material is not set. This is because, in the case in which the conveyance speed is set to “600 mm/s”, the halogen heater does not have enough capacity to heat the fixing belt 401 to the required fixing temperature, at which an appropriate amount of the heat for the fixing is given to the recording material.

The temperature setting portion 263 (see FIG. 2) can set the temperature of the fixing belt 401 based on the temperature table to a first temperature in a case in which the basis weight of the recording material is the first basis weight and set to the second temperature lower than the first temperature in a case in which the basis weight of the recording material is a second basis weight smaller than the first basis weight. The CPU 222 may change the temperature of the fixing belt 401 based on the set temperature. Incidentally, since it takes time for the fixing belt 310 to be at the set temperature, it is necessary to suspend execution of the mixed job which is being executed (referred to as a print operation), and by performing the suspension, productivity of the recording material is decreased. In addition, upon changing the conveyance speed during execution of the mixed job, it is necessary to suspend the mixed job which is being executed until the conveyance speed becomes at a set speed, and by performing the suspension, the productivity of the recording material is decreased.

### <Operating Mode>

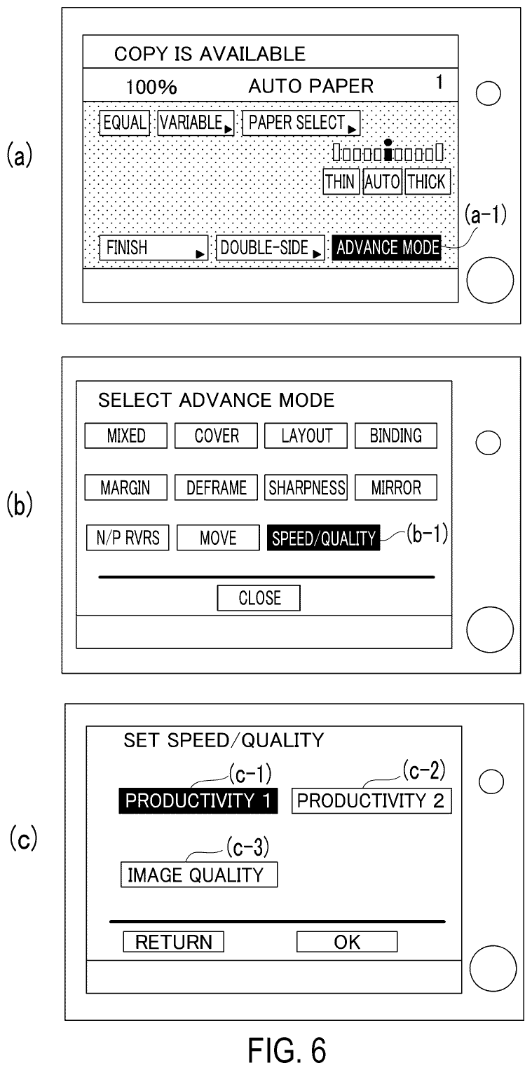

Next, operating modes which can be executed by the fixing device 311 in the present Embodiment will be described using part (a) of FIG. 6 through part (d) of FIG. 6. The fixing device 311 is capable of executing a productivity prioritized mode and an image quality prioritized mode, and furthermore, the productivity priority mode is divided into two modes of a mixed productivity prioritized mode and a productivity prioritized mode for each type of the sheet. Through a setting screen displayed on the display 225 by the CPU 222, a user can set the operating mode. Incidentally, the selected operating mode is stored in the memory 223.

Part (a) of FIG. 6 is an initial screen. When a user selects an “advanced mode” (a-1), which is a software key, from the initial screen, the CPU 222 displays a selection screen for the advanced mode shown in part (b) of FIG. 6 on the display 225. When the user selects a “speed/image quality” (b-1), which is a software key, from the selection screen for the advanced mode, the CPU 222 displays a setting screen for a speed/image quality priority adjustment shown in part (c) of FIG. 6 on the display 225.

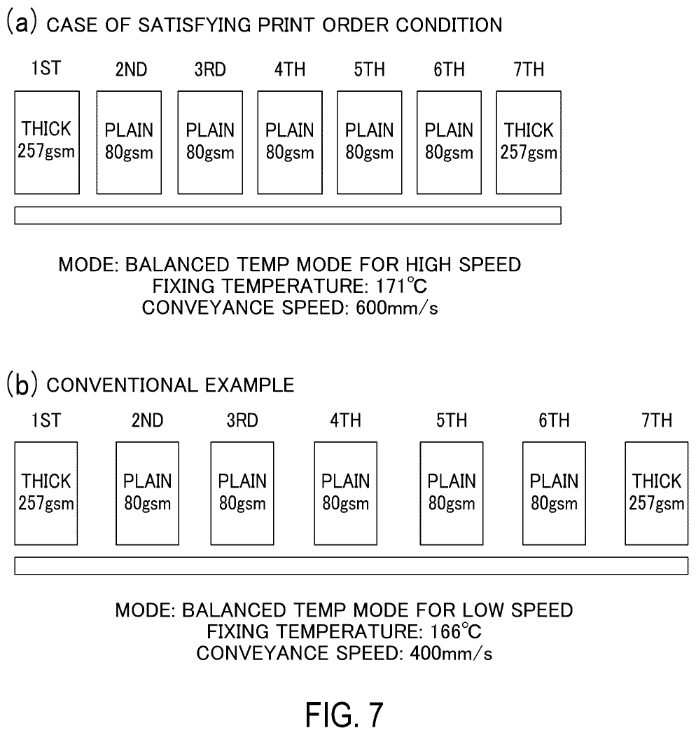

If the user sets a “prioritize productivity 1” (c-1) and operates “OK”, then the mixed job can be executed in the mixed productivity prioritized mode (a second mode). In the present Embodiment, in the case in which the mixed productivity prioritized mode is set, either of the temperature table for the “balanced temperature control mode for the high speed” or the temperature table for the “balanced temperature control mode for the low speed” is used. It will be described below whether the temperature table for the “balanced temperature control mode for the high speed” or the temperature table for the “balanced temperature control mode for the low speed” is used (see FIG. 7).

If the user sets a “prioritize productivity 2” (c-2) and operates “OK”, then the mixed job can be executed in the productivity prioritized mode for each type of the sheet (first mode). Upon setting to the present mode, the temperature table for the “balanced temperature control mode for the high speed”, which is shown in part (a) of FIG. 5, is used for the high quality paper having the basis weight of 60 gsm or more and 256 gsm or less and for the coated paper having the basis weight of 64 gsm or more and 220 gsm or less, and the temperature table for the “balanced temperature control mode for the low speed”, which is shown in part (b) of FIG. 5, is used for the high quality paper having the basis weight of 257 gsm or more and 500 gsm or less and for the coated paper having the basis weight of 221 gsm or more and 500 gsm or less. Incidentally, the productivity prioritized mode for each type of the sheet can realize improvement of the image quality compared to the mixed productivity prioritized mode.

If the user sets the “prioritize image quality” (c-3) and operates “OK”, then the mixed job can be executed in the image quality prioritized mode. The image quality prioritized mode is a mode in which the image quality of the formed image is prioritized. Therefore, as shown in the temperature table for the image quality prioritized temperature control mode, which is shown in part (c) of FIG. 5, it is configured so that the temperature can be changed corresponding to the basis weight more finely in the image quality prioritized mode than in the productivity prioritized mode. In other words, the image quality of the toner image formed on the recording material depends on the amount of the heat given to the toner image. There is an optimal temperature for fixing the toner image corresponding to the basis weight of the recording material, and by that optimal temperature being given to the toner image, the image quality of the toner image can be improved. The temperature table for the image quality prioritized temperature control mode defines, corresponding to the basis weight and the type of the recording material, the fixing temperature more finely. Therefore, in the case in which the mixed job is executed in the image quality prioritized mode, it may be more often that the temperature of the fixing belt 310 is changed than in the case in which the mixed job is executed in the productivity prioritized mode.

### <Mixed Productivity Prioritized Mode>

Next, the mixed productivity prioritized mode will be described using part (a) of FIG. 7 and part (b) of FIG. 7. Part (a) of FIG. 7 shows a case in which a print order condition is satisfied, and part (b) FIG. 7 shows a Conventional Example. The print order condition may be, for example, a condition in which thick papers are not consecutive for “two or more sheets” and plain papers are consecutive for “five or more sheets”.

Incidentally, here, as for the print order condition, the case in which the condition is set for the thick paper to “two or more sheets” and for the plain paper to “five or more sheets” is described as an example, however, it is not limited thereto. A number of sheets of the recording material, such as “two or more sheets” and “five or more sheets” described above, may be changeable based on the detection result detected by the temperature and humidity sensor 252. For example, if the inside temperature and the inside humidity detected by the temperature and humidity sensor 252 are a predetermined value (e.g., 20° C. and 60%) or lower, then the conditions are set to “two or more sheets” and “five or more sheets” described above, and if the inside temperature and the inside humidity are higher than the predetermined value, then the conditions may be changed to “three or more sheets” and “eight or more sheets”.

As shown in part (a) of FIG. 7, in a case of the mixed job in which a first sheet is the thick paper of 257 gsm, a second sheet through a sixth sheet are the plain papers of 80 gsm, and the seventh sheet is the thick paper of 257 gsm, in the temperature table for the balanced temperature control mode for the high speed shown in part (a) of FIG. 5, setting values for the fixing temperature for the recording material of 257 gsm are not defined. Therefore, in the Conventional Example, as shown in part (b) of FIG. 7, in the case of executing the mixed job in which the thick paper of 257 gsm and the plain paper of 80 gsm are mixedly included, it is necessary to use the temperature table for the balanced temperature control mode for the low speed (part (b) of FIG. 5).

To the contrary, in the present Embodiment, after the first thick paper of 257 gsm is printed at the conveyance speed (600 mm/s) and the fixing temperature (171° C.) for the plain paper of 80 gsm, the second sheet through the sixth sheet of the plain paper of 80 gsm are printed. By this, the heat deprived by a paper passing of the first sheet is recovered, and since the seventh sheet of the thick paper of 257 gsm can be fixed at the conveyance speed (600 mm/s) and the fixing temperature (171° C.), the print operation is started using the temperature table for the balanced temperature control mode for the high speed (part (a) of FIG. 5). In this manner, when the mixed productivity prioritized mode is input, in a case of receiving the mixed job in which the thick papers are not consecutive for two or more sheets (consecutive for a first number or more of the sheets) and the plain papers are consecutive for five or more sheets (consecutive for a second number or more of the sheets) after the thick paper, the conveyance speed is set to the conveyance speed for the balanced temperature control mode for the high speed (600 mm/s) and the fixing temperature is set to a common temperature to the fixing temperature for the plain paper (171° C.), and the execution is started.

However, in order to execute the mixed job using the common temperature as described above, as an environment condition, for example, it is necessary for the inside temperature to be “21° C. or higher and lower than 26° C.” and for the inside humidity to be “30% or higher and lower than 60%”. For example, in a low temperature environment in which the inside temperature is “lower than 15° C.”, since a temperature of the recording material is low, even if the heat is applied at the common temperature, the toner may not be sufficiently melted causing fixing defect and the image quality of the toner image may be decreased. As such, since the fixing performance for the toner image to the recording material varies depending on the inside temperature and the inside humidity, the environment condition is set in order to guarantee the fixing performance for the toner image for the case in which the common temperature is used.

In the present Embodiment, if the environment condition described above is not satisfied, by notifying a user a fact that the environment condition is not proper for the mixed productivity prioritized mode, it becomes possible for the user to know whether or not the mixed productivity prioritized mode is applicable. Hereinafter, the present Embodiment which realize this will be described, however, in order to make the description be easily understood, it will be described by dividing a case into during standby, during job start and during job execution. Incidentally, “during standby” is a duration when the image forming apparatus 101 is in a waiting state in which the image forming apparatus 101 is capable of starting the image forming operation to the recording material immediately in response to the input of the image forming job.

### <Process During Standby>

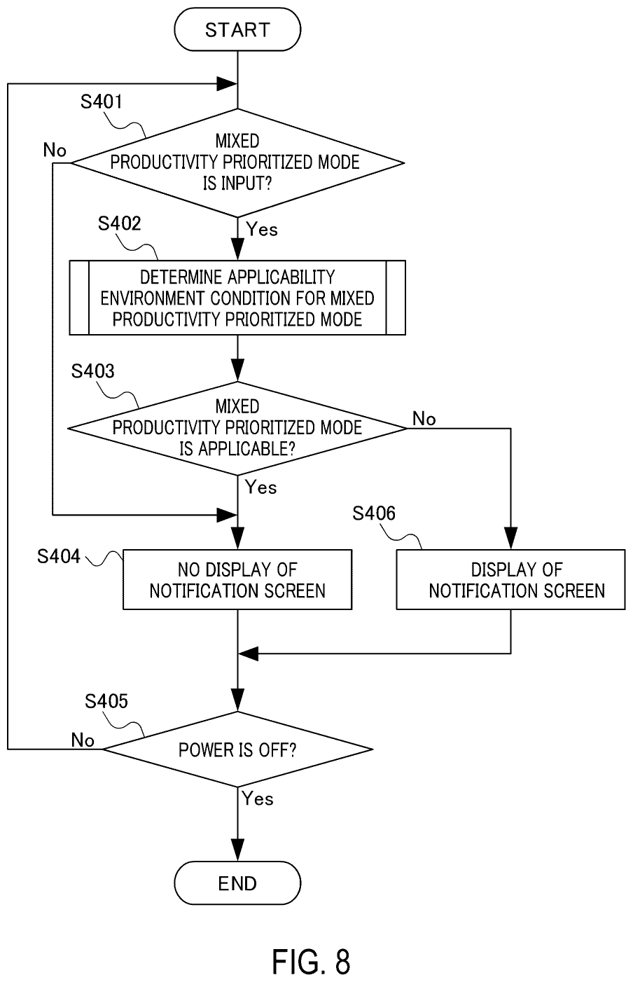

First, a process during standby will be described using FIG. 8 through Figure while referencing to FIG. 2. FIG. 8 is a flowchart showing the process during standby. The process during standby is started by the CPU 222 by a power of the image forming apparatus 101 being turned on.

As shown in FIG. 8, the CPU 222 refers to the operating mode stored in the memory 223, and determines whether or not the mixed productivity prioritized mode is input (S401). If the mixed productivity prioritized mode is not input (No in S401), then the CPU 222 jumps the process to a process of S404. If the mixed productivity prioritized mode is input (Yes in S401), then the CPU 222 executes an “applicability determination process” for the mixed productivity prioritized mode (S402).

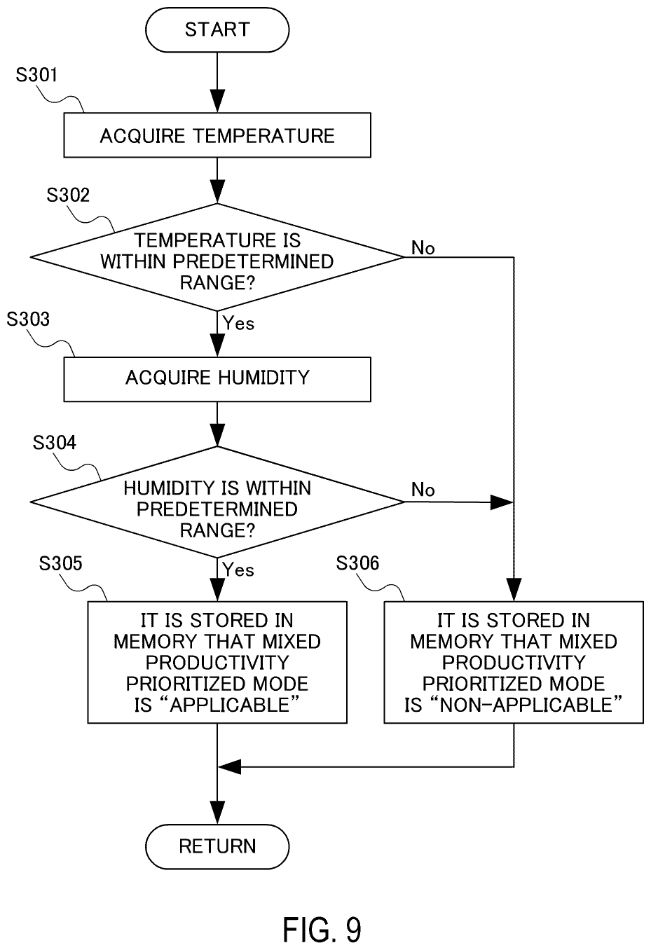

In FIG. 9, the “applicability determination process” for the mixed productivity prioritized mode (S402 in FIG. 8) is shown. As shown in FIG. 9, the CPU 222 acquires the inside temperature detected by the temperature and humidity sensor 252 (S301), and determines whether or not the acquired inside temperature is within the predetermined range (e.g., 21° C. or higher and lower than 26° C.) (S302). If the inside temperature is within the predetermined range (Yes in S302), then the CPU 222 acquires the inside humidity detected by the temperature and humidity sensor 252 (S303), and determines whether or not the acquired inside humidity is within the predetermined range (e.g., 30% or higher and lower than 60%) (S304). If both the inside temperature and the inside humidity are within the predetermined ranges (Yes in S304), then the CPU 222 stores into the memory 223 that the mixed productivity prioritized mode can be applied (S305). On the other hand, if at least one of the inside temperature and the inside humidity is not within the predetermined range (No in S302 or No in S304), then the CPU 222 stores into the memory 223 that the mixed productivity prioritized mode cannot be applied (S306).

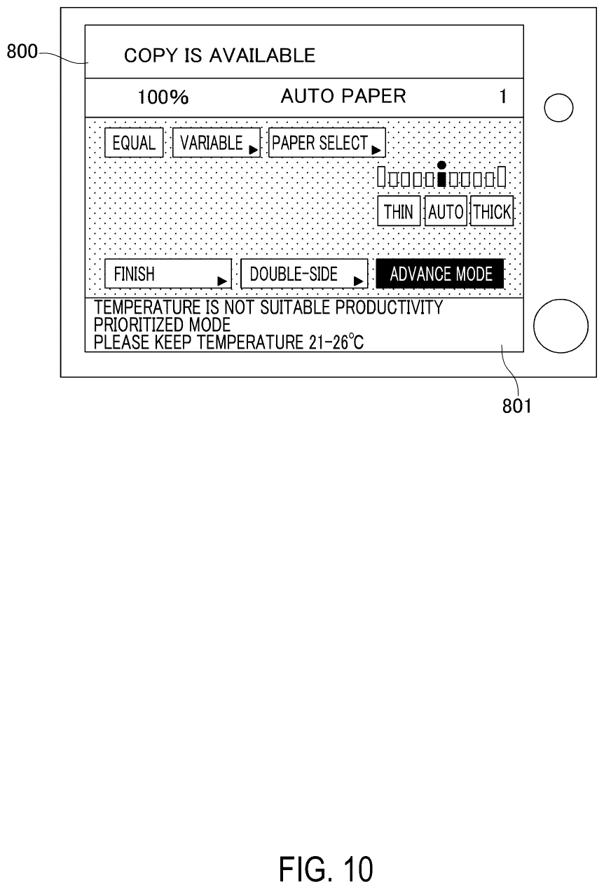

Returning to the description for FIG. 8, after executing the “applicability determination process” for the mixed productivity prioritized mode, the CPU 222 determines whether or not it is an environment in which the mixed productivity prioritized mode can be applied (S403). If it is an environment in which the mixed productivity prioritized mode cannot be applied (No in S403), then the CPU 222 displays, in order to notify a user that it is out of the environment in which it can be operated in the mixed productivity prioritized mode, a “notification screen” (FIG. 10), which will be described below, on the display 225 (S406). On the other hand, if it is the environment in which the mixed productivity prioritized mode can be applied (Yes in S403), since it is not necessary to notify a user that it is out of the environment in which it can be operated in the mixed productivity prioritized mode, the CPU 222 does not display the “notification screen” (FIG. 10) on the display 225 (S404).

After the display control of the “notification screen”, the CPU 222 determines whether or not the power of the image forming apparatus 101 is turned off (S405). If the power of the image forming apparatus 101 is turned off (Yes in S405), then the CPU 222 ends the “process during standby”. If the power of the image forming apparatus 101 is not turned off (No in S405), then the CPU 222 returns the process to the process of S401, and repeats the processes of S401 through S406.

FIG. 10 shows the “notification screen” which is displayed on the display 225 during standby of the image forming apparatus 101. As shown in FIG. 10, a “notification screen” 801 is displayed on a status line provided to a lower portion of an “initial screen” 800. In the “notification screen” 801, in order to notify a user that the environment condition suitable for the mixed productivity prioritized mode is not satisfied, it is displayed that “temperature is not suitable for the productivity prioritized mode”. In addition, in order to notify a user that the environment condition suitable for the mixed productivity prioritized mode, it is displayed that “please keep the temperature 21-26° C.” Incidentally, here, the example in which only the “temperature” is displayed as the environment condition, however, the “humidity” may also/only be displayed.

### <Process During Job Start>

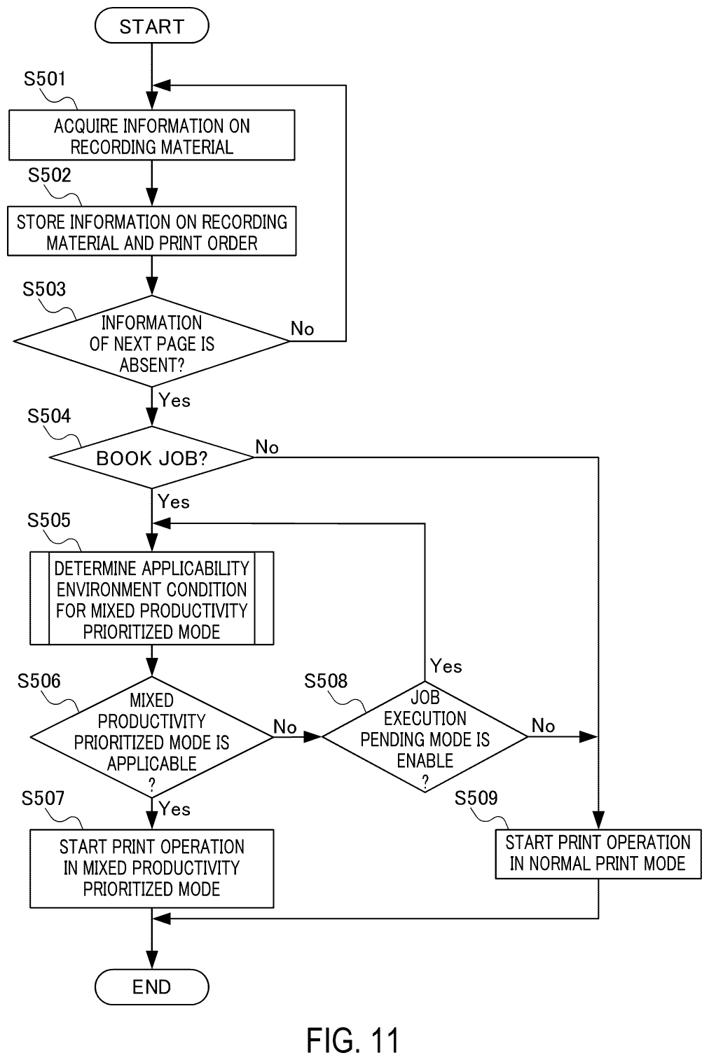

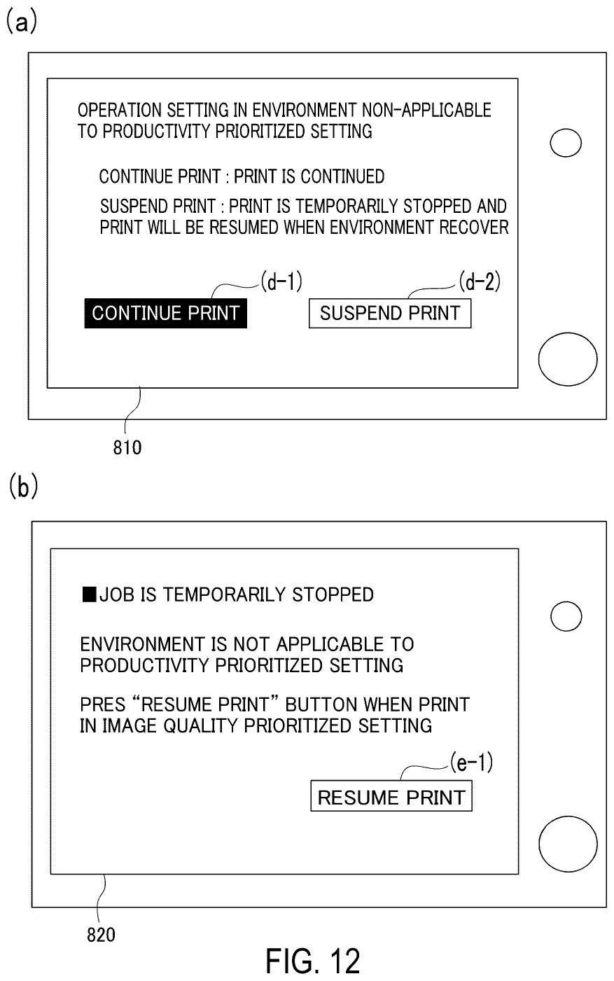

Next, a process during job start will be described using FIG. 11 through part (b) of FIG. 12 while referencing to FIG. 2. FIG. 11 is a flowchart showing the process during job start in the Embodiment 1. The process during job start is started by the CPU 222, when the mixed productivity prioritized mode has been input, by receiving the start instruction for the mixed job from the operating portion 224 (or the client PC 103).

As shown in FIG. 11, the CPU 222 acquires, upon receiving the start instruction for the mixed job, information on the recording material of the job in order from a first sheet via an acquiring portion 261, and acquires a print order according to the acquired information on the recording material (S501). The information on the recording material which can be acquired by the acquiring portion 261 includes information on the basis weight of the recording material. The CPU 222 stores the acquired information on the recording material and the print order into the memory 223 (S502). The CPU 222 repeats, until the information on the recording material can no longer be acquired (S503), the acquiring (S501) and the storing (S502) of the information on the recording material and the print order.

The CPU 222 determines, with referring to the information on the recording material and the print order stored in the memory 223, whether or not the acquired mixed job is a book job (S504). The book job is a job, for example, of the mixed jobs in which the thick paper and the plain paper are mixedly included, which satisfies the print order condition. If the acquired mixed job is not the book job (No in S504), then the CPU 222 changes the operating mode to a normal print mode (productivity prioritized mode for each type of the sheet, hereinafter the same applies), and starts the print operation in the normal print mode (S509). In the normal print mode, the temperature table for the balanced temperature control mode for the high speed (part (a) of FIG. 5) and the temperature table for the balanced temperature control mode for the low speed (part (b) of FIG. 5) are used for each recording material which is passed through. Therefore, upon switching the conveyance speed and/or the fixing temperature, the print operation may be suspended.

If the acquired mixed job is the book job (Yes in S504), then the CPU 222 executes the “applicability determination process” (see FIG. 9) for the mixed productivity prioritized mode described above (S505). After executing the “applicability determination process” for the mixed productivity prioritized mode, the CPU 222 determines whether or not it is an environment in which the mixed productivity prioritized mode can be applied (S506). Incidentally, at this time, the CPU 222 does not display a “notification screen” (part (b) of FIG. 12), which will be described below, on the display 225. If it is the environment in which the mixed productivity prioritized mode can be applied (Yes in S506), then the CPU 222 starts the print operation in the mixed productivity prioritized mode (S507).

If it is not the environment in which the mixed productivity prioritized mode can be applied (No in S506), then the CPU 222 refers to a job execution pending flag stored in the memory 223, and determines whether or not a job execution pending mode is enabled (S508). For example, the job execution pending flag “1” indicates that the job execution pending mode is enabled, and the job execution pending flag “0” indicates that the job execution pending mode is disabled. The job executing pending flag can be set by a user from an “operation setting screen” (part (a) of FIG. 12), which will be described below, before the job is started.

If the job execution pending mode is enabled (Yes in S508), then the CPU 222 suspends the start of the print operation and, in order to notify a user that it is out of the environment in which it can be operated in the mixed productivity prioritized mode, displays the “notification screen” (part (b) of FIG. 12), which will be described below, on the display 225. And the CPU 222 repeats, until it becomes the environment in which the mixed productivity prioritized mode can be applied or until a “resume print” (e-1) in the “notification screen” shown in part (b) of FIG. 12 is operated, the processes of S505, S506 and S508 in the state in which the start of the print operation is suspended.

If the job execution pending mode is not enabled (No in S508), in other words, if the “resume print” (e-1) in the “notification screen”, which will be described below, is operated, then the CPU 222 changes the operating mode to the normal print mode and starts the print operation (S509). In this manner, if the environment condition is not satisfied before the mixed job is started, the CPU 222 does not start but suspends the mixed job until the “resume print” (e-1) is operated, and in response to the “resume print” (e-1) being operated and the normal print mode being input, starts the mixed job in the normal print mode.

The “operation setting screen” is shown in part (a) of FIG. 12, and the “notification screen” during job start is shown in part (b) of FIG. 12, and each will be described. An “operation setting screen” 810 shown in part (a) of FIG. 12 is a screen for setting the operation in the case in which the environment condition suitable for the mixed productivity prioritized mode is not satisfied, and in response to a user setting the prioritize productivity 1 (c-1) in the “setting screen for the speed/image quality priority adjustment” (see part (c) of FIG. 6) and operating “OK”, is displayed on the display 225.

In the mixed productivity prioritized mode, a situation in which the mode cannot be continued due to the environment condition (the inside temperature and/or the inside humidity) may arise. Therefore, the “operation setting screen” 810 is a screen for letting a user set in advance whether, in the case in which it is not the environment in which the mixed productivity prioritized mode can be applied, to suspend the execution of the job and stand by until the inside temperature and/or the inside humidity comes to be in the predetermined range (environment condition) or to execute (continue) the job in the “normal print mode”. If a user selects a “continue print” (d-1) on the “operation setting screen” 810, then in order to execute the job in the “normal print mode”, “0” is set to the job execution pending flag. If a user selects a “suspend print” (d-2) on the “operation setting screen” 810, then in order to suspend the job in the “mixed productivity prioritized mode”, “1” is set to the job execution pending flag.

A “notification screen” 820 shown in part (b) of FIG. 12 is displayed on the display 225 in the case in which the job execution pending mode is enabled. The “notification screen” 820 notifies a user that the environmental condition suitable for the mixed productivity prioritized mode is not satisfied, and in addition that the execution of the job is suspended until the inside temperature and/or the inside humidity comes to be in the predetermined range (environment condition). Therefore, as shown in part (b) of FIG. 12, in the “notification screen” 820, messages such as “the job is suspended (temporarily stopped)”, “it is an environment in which the productivity prioritized setting cannot be applied”, and “the print will be resumed when the temperature comes to be 21° C.-26° C.” are displayed. And in the “notification screen” 820, the “resume print” (e-1), which allows a user to resume the pending job before the inside temperature and/or the inside humidity comes to be in the predetermined range, is displayed. When the “resume print” (e-1) is operated by a user, then the job execution pending flag stored in the memory 223 is updated to “0”, and the print operation is resumed in the normal print mode. In the “notification screen” 820, a massage which promotes a user to switch to the normal print mode is displayed.

### <Process During Job Execution>

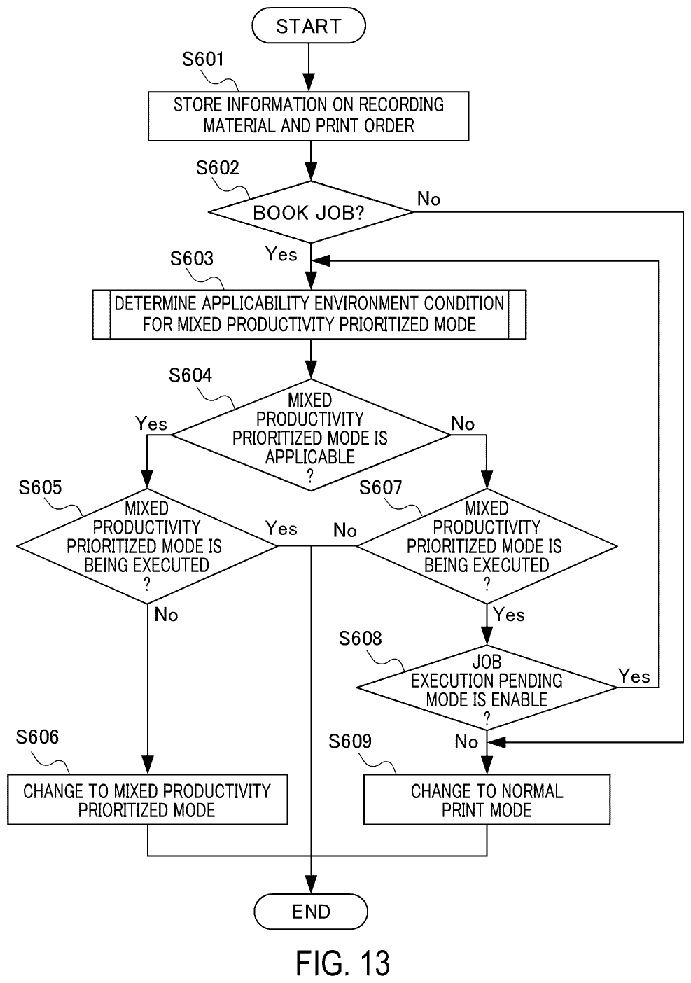

Next, a process during job execution will be described using FIG. 13 while referencing to FIG. 2. FIG. 13 is a flowchart showing the process during job execution in the Embodiment 1. The process during job execution is repeatedly executed by the CPU 222 for each one page of the recording material until the mixed job which is being executed is completed.

As shown in FIG. 13, the CPU 222 acquires the information on the recording material for a plural number of sheets of the recording material of a next and subsequent pages via the acquiring portion 261 during execution of the mixed job, acquires the print order according to the acquired information on the recording material, and stores the acquired information on the recording material and the print order in the memory 223 (S601). The CPU 222 repeats, until the information on the recording material can no longer be acquired, the acquiring and the storing of the information on the recording material and the print order.

The CPU 222 determines, by referring to the information on the recording material and the print order stored in the memory 223, whether or not the job, which includes the plural number of sheets of the recording material of the next and subsequent pages, is the book job (S602). If it is not the book job (No in S602), then the CPU 222 changes the operating mode from mixed productivity prioritized mode to the normal print mode, and performs the print operation in the normal print mode (S609).

If it is the book job (Yes in S602), then the CPU 222 executes the “applicability determination process” (see FIG. 9) for the mixed productivity prioritized mode described above (S603). After executing the “applicability determination process” for the mixed productivity prioritized mode, the CPU 222 determines whether or not it is the environment in which the mixed productivity prioritized mode can be applied (S604). If it is the environment in which the mixed productivity prioritized mode can be applied (Yes in S604), then the CPU 222 determines, at a current moment, whether or not the print operation is being executed in the mixed productivity prioritized mode (S605). Incidentally, at this time, the CPU 222 does not display the “notification screen” (part (b) of FIG. 12) described above on the display 225.

If the print operation is being executed in the mixed productivity prioritized mode at the current moment (Yes in S605), then the CPU 222 continues the print operation in the mixed productivity prioritized mode. On the other hand, if the print operation is not being executed in the mixed productivity prioritized mode at the current moment (No in S605), then the CPU 222 changes the operating mode to the mixed productivity prioritized mode (S606), and executes the print operation in the mixed productivity prioritized mode. In this manner, during execution of the job, in the case in which the inside temperature and/or the inside humidity satisfies the environment condition, the print operation is executed in the mixed productivity prioritized mode.

On the other hand, if it is not the environment in which the mixed productivity prioritized mode can be applied (No in S604), then the CPU 222 determines, at a current moment, whether or not the print operation is being executed in the mixed productivity prioritized mode (S607). If the print operation is being executed in the mixed productivity prioritized mode at the current moment (Yes in S607), then the CPU 222 refers to the job execution pending flag stored in the memory 223, and determines whether or not the job execution pending mode is enabled (S608).

If the job execution pending mode is enabled (Yes in S608), then the CPU 222 suspends the print operation, and in order to notify a user that it is out of the environment in which it can be operated in the mixed productivity prioritized mode, displays the “notification screen” (part (b) of FIG. 12) described above on the display 225. And the CPU 222 repeats, until it becomes the environment in which the mixed productivity prioritized mode can be applied or until the “resume print” (e-1) in the “notification screen” shown in part (b) of FIG. 12 is operated, the processes of S603, S604, S607 and S608 in the state in which the start of the print operation is suspended.

If the job execution pending mode is not enabled (No in S608), in other words, if the “resume print” (e-1) in the “notification screen” is operated, then the CPU 222 changes the operating mode to the normal print mode and resume the print operation (S609). In this manner, if the environment condition is not satisfied during execution of the mixed job in the mixed productivity prioritized mode, the mixed job is suspended until the “resume print” (e-1) is operated, and in response to the “resume print” (e-1) being operated and the normal print mode being input, the mixed job is resumed in the normal print mode. Incidentally, if the print operation is not being executed in the mixed productivity prioritized mode (No in S607), then the CPU 222 continues the print operation in the normal print mode after the change in S609.

As described above, in the present Embodiment, during the “mixed productivity prioritized mode”, in which the mixed job, in which the recording material having different fixing temperatures are mixedly included, is executed using the common temperature, if the environmental condition for guaranteeing the fixing performance for the toner image is not satisfied, the fact that the environment condition is not suitable for the mixed productivity prioritized mode is notified to a user. By this, it becomes possible for a user to know whether or not it is the environment in which the mixed productivity prioritized mode can be applied, so that the print operation using the common temperature in the “mixed productivity prioritized mode” is not executed in the environment condition in which the image quality of the toner image may be decreased.

### Embodiment 2

As described above, in the process during job start in the Embodiment 1, until it becomes the environment in which the mixed productivity prioritized mode can be applied or until the “resume print” (e-1) on the “notification screen” shown in part (b) of FIG. 12 is operated, the start of the print operation is suspended. In addition, in the process during job execution in the Embodiment 1 (see FIG. 13), until it becomes the environment in which the mixed productivity prioritized mode can be applied or until the “resume print” (e-1) on the “notification screen” shown in part (b) of FIG. 12 is operated, the print operation is suspended. And, in response to the operation of the “resume print” (e-1) by a user, the print operation is executed in the normal print mode. However, for a user who wants to prioritize the productivity, it is not desirable that the print operation is not executed until it becomes the environment in which the mixed productivity prioritized mode can be applied or until the “resume print” (e-1) is operated, and there is a need to execute the print operation, even it is an environment in which the mixed productivity prioritized mode cannot be applied, by forcibly applying the mixed productivity prioritized mode. Hereinafter, an Embodiment 2, which realizes this, will be described with dividing into the cases.

### <Process During Job Start>

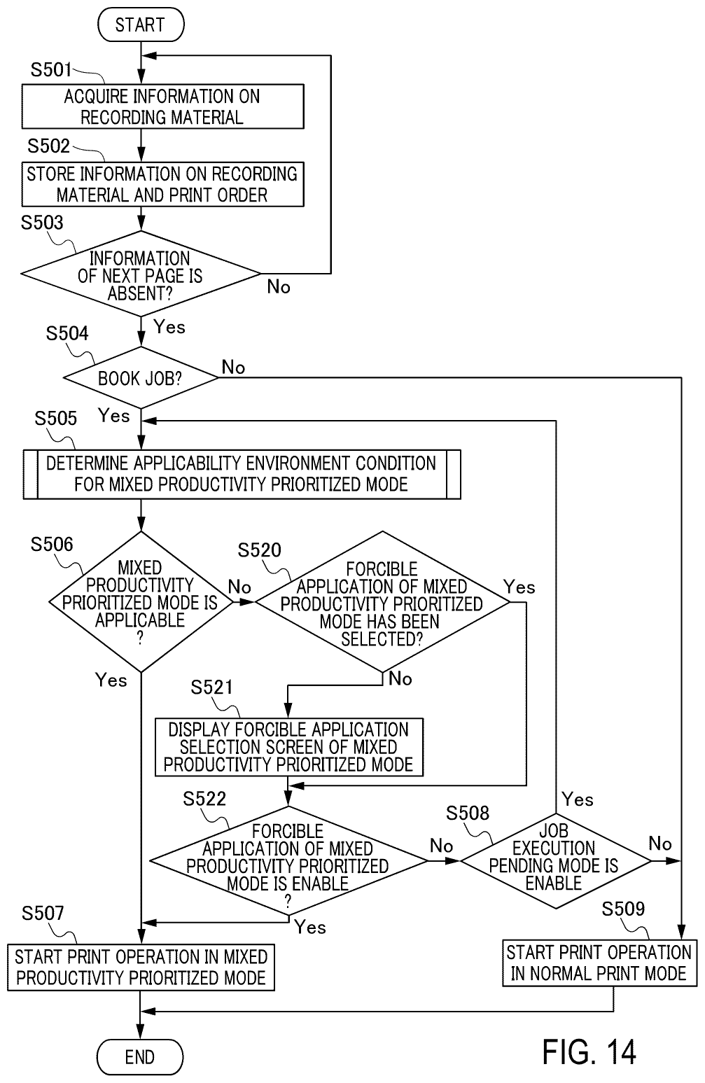

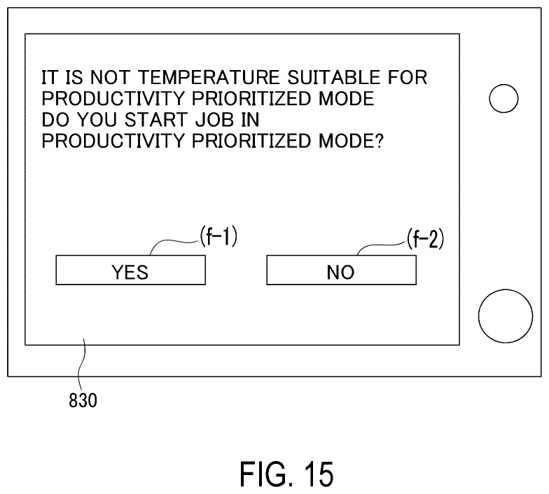

First, the process during job start in the Embodiment 2 will be described using FIG. 14 and FIG. 15 while referencing to FIG. 2. FIG. 14 is a flowchart showing the process during job start in the Embodiment 2. Compared to the process during job start in the Embodiment 1 described above (see FIG. 11), the process during job start in the Embodiment 2 shown in FIG. 14 differs in S520, S521 and S522. Therefore, hereinafter, the processes of S520, S521 and S522 will be mainly described, and to the same processes as those in the process during job start in the Embodiment 1, the same step numbers will be attached, and description thereof will be simplified or omitted.

If the mixed job is the book job (Yes in S504), then the CPU 222 executes the “applicability determination process” (see FIG. 9) (S505). After executing the “applicability determination process” for the mixed productivity prioritized mode, the CPU 222 determines whether or not it is the environment in which the mixed productivity prioritized mode can be applied (S506). If it is not the environment in which the mixed productivity prioritized mode can be applied (No in S506), then the CPU 222 determines whether or not a “forcible application” of the mixed productivity prioritized mode has been selected (S520). For example, a forcible application flag “0” indicates that the “forcible application” has not been selected, the forcible application flag “1” indicates that the “forcible application” has been selected, and the forcible application flag “2” indicates that the “forcible application” has been selected but the mixed productivity prioritized mode will not be forcibly applied. The forcible application flag can be selected by a user from a “forcible application selection screen” (FIG. 15), which will be described below.

If the “forcible application” of the mixed productivity prioritized mode has been selected (Yes in S520), then the CPU 222 jumps the process to a process of S522. If the “forcible application” of the mixed productivity prioritized mode has not been selected (No in S520), then the CPU 222 suspends the start of the print operation and displays the “forcible application selection screen” (FIG. 15), which will be described below, on the display 225 (S521). And the CPU 222 refers to the forcible application flag stored in the memory 223, and determines whether or not to forcibly apply the mixed productivity prioritized mode (S522).

For example, if the forcible application flag is “1” and the mixed productivity prioritized mode is forcibly applied (Yes in S522), then the CPU 222 starts the print operation in the mixed productivity prioritized mode even if the environment condition is not satisfied (S507). If the forcible application flag is “2” and the mixed productivity prioritized mode is not forcibly applied (No in S522), then the CPU 222 refers to the job execution pending flag stored in the memory 223, and determines whether or not the job execution pending mode is enabled (S508).

If the job execution pending mode is enabled (Yes in S508), then the CPU 222 displays, in order to notify a user that it is out of the environment in which it can be operated in the productivity prioritized mode, the “notification screen” described above (part (b) of FIG. 12) on the display 225. On the other hand, if the job execution pending mode is not enabled (No in S508), then the CPU 222 changes the operating mode to the normal print mode, and starts the print operation (S509).

The “forcible application selection screen”, which is displayed during job start, will be described using FIG. 15. As shown in FIG. 15, in a “forcible application selection screen” 830, in order to notify a user that the environment condition suitable for the mixed productivity prioritized mode is not satisfied, a message that “it does not become a temperature suitable for the productivity prioritized mode.” is displayed. That is, the “forcible application selection screen” also serves as a “notification screen”. In addition, in the “forcible application selection screen” 830, in order to promote a user a selection of where or not the mixed productivity prioritized mode can be forcibly applied, that is, a selection to forcibly execute the mixed job in the mixed productivity prioritized mode, a question such as “Do you start the job in the productivity prioritized mode?” is displayed. And the “forcible application selection screen” 830 includes “Yes” (f-1) and “No” (f-2) for allowing a user to select whether or not the mixed productivity prioritized mode can be forcibly applied. If the “Yes” (f-1) is operated by a user, then it is stored as the forcible application flag is “1” in the memory 223, and if the “No” (f-2) is operated by a user, then it is stored as the forcible application flag is “2” in the memory 223.

### <Process During Job Execution>

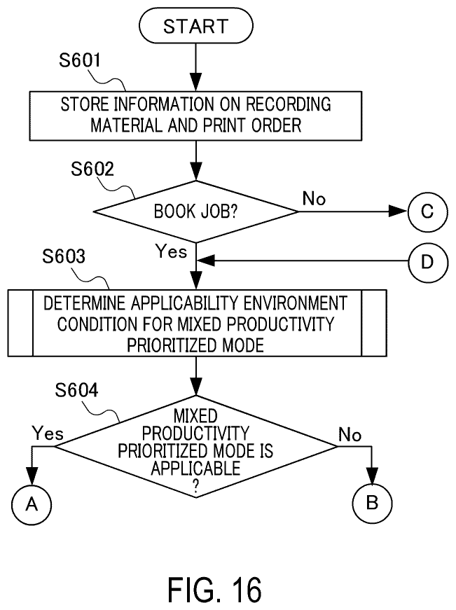

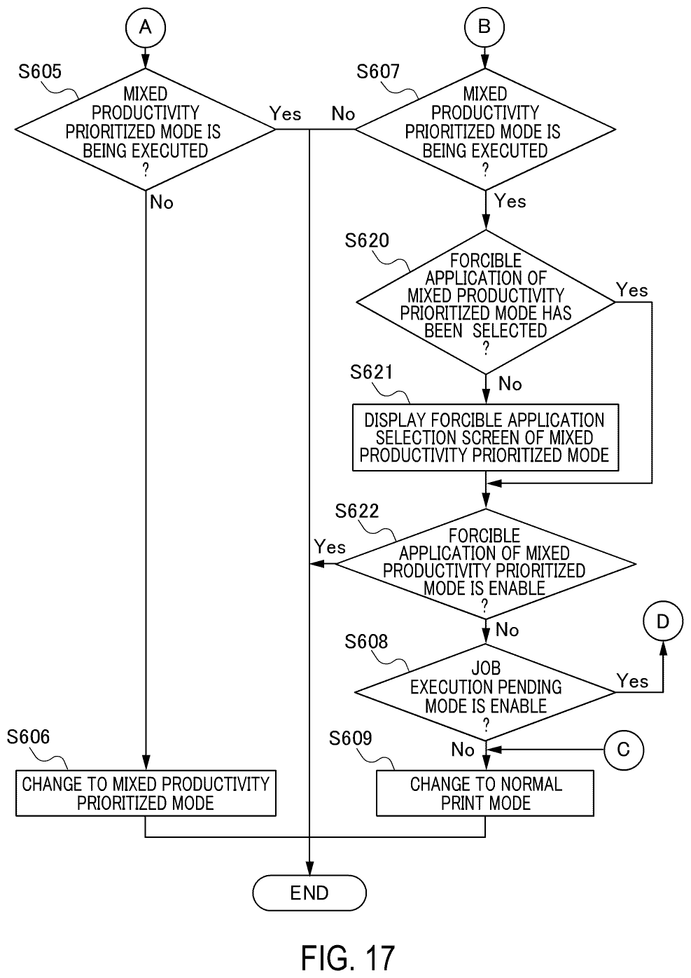

Next, the process during job execution in the Embodiment 2 will be described using FIG. 16 through FIG. 18 while referencing to FIG. 2. FIG. 16 and FIG. 17 are flowcharts showing the process during job execution in the Embodiment 2. Here, for convenience of illustration, a series of the process during job execution are shown with divided into two parts. Compared to the process during job execution in the Embodiment 1 described above (see FIG. 13), the process during job execution in the Embodiment 2 shown in FIG. 16 and FIG. 17 differs in S620, S621 and S622. Therefore, hereinafter, the processes of S620, S621 and S622 will be mainly described, and to the same processes as those in the process during job execution in the Embodiment 1, the same step numbers will be attached, and description thereof will be simplified or omitted.

As shown in FIG. 16, the CPU 222 stores the information on the recording material and the print order in the memory 223 (S601). The CPU 222, by referring to the information on the recording material and the print order stored in the memory 223, determines whether or not the job, which includes the plural number of sheets of the recording material of the next and subsequent pages, is the book job (S602). If it is not the book job (No in S602), then the CPU 222 jumps the process to the process of S609 shown in FIG. 17. If it is the book job (Yes in S602), then the CPU 222 executes the “applicability determination process” (see FIG. 9) (S603), and determines whether or not it is the environment in which the mixed productivity prioritized mode can be applied (S604). If it is the environment in which the mixed productivity prioritized mode can be applied (Yes in S604), then the CPU 222 executes the process of S605 shown in FIG. 17. On the other hand, if it is not the environment in which the mixed productivity prioritized mode can be applied (No in S604), then the CPU 222 executes the process of S607 shown in FIG. 17.

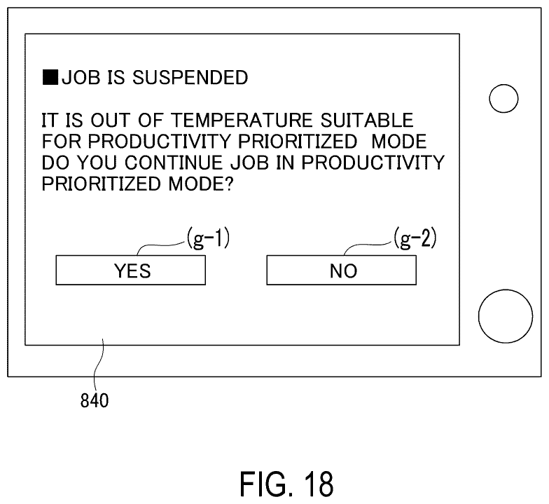

As shown in FIG. 17, if the print operation is being executed in the mixed productivity prioritized mode at a current moment (Yes in S607), the CPU 222 determines whether or not the “forcible application” of the mixed productivity prioritized mode has been selected (S620). The forcible application flag can be selected by a user from a “forcible application selection screen” (FIG. 18), which will be described below.

If the “forcible application” of the mixed productivity prioritized mode has been selected (Yes in S620), then the CPU 222 jumps the process to a process of S622. If the “forcible application” of the mixed productivity prioritized mode has not been selected (No in S620), then the CPU 222 suspends the print operation and displays the “forcible application selection screen” (FIG. 18), which will be described below, on the display 225 (S621). And the CPU 222 refers to the forcible application flag stored in the memory 223, and determines whether or not to forcibly apply the mixed productivity prioritized mode (S622).

For example, if the forcible application flag is “1” and the mixed productivity prioritized mode is forcibly applied (Yes in S622), then the CPU 222 starts the print operation in the mixed productivity prioritized mode. If the forcible application flag is “2” and the mixed productivity prioritized mode is not forcibly applied (No in S622), then the CPU 222 refers to the job execution pending flag stored in the memory 223, and determines whether or not the job execution pending mode is enabled (S608).

If the job execution pending mode is enabled (Yes in S608), then the CPU 222 displays, in order to notify a user that it is out of the environment in which it can be operated in the productivity prioritized mode, the “notification screen” described above (part (b) of FIG. 12) on the display 225. On the other hand, if the job execution pending mode is not enabled (No in S608), then the CPU 222 changes the operating mode to the normal print mode, and starts the print operation (S609).

The “forcible application selection screen”, which is displayed during job execution, will be described using FIG. 18. As shown in FIG. 18, in a “forcible application selection screen” 840, in order to notify a user that the environment condition suitable for the mixed productivity prioritized mode is not satisfied, a message that “it became out of a temperature suitable for the productivity prioritized mode.” is displayed. That is, the “forcible application selection screen” also serves as a “notification screen”. In addition, in order to promote a user a selection of whether or not the mixed productivity prioritized mode can be forcibly applied, a question such as “do you continue the job in the productivity prioritized mode?” is displayed. And in the “forcible application selection screen” 840, “Yes” (g-1) and “No” (g-2) for allowing a user to select whether or not the mixed productivity prioritized mode can be forcibly applied. If the “Yes” (g-1) is operated by a user, then it is stored as the forcible application flag is “1” in the memory 223, and if the “No” (g-2) is operated by a user, then it is stored as the forcible application flag is “2” in the memory 223.

As described above, according to the present Embodiment, during the mixed productivity prioritized mode in which the mixed job is executed using the common temperature, even if it is the environment condition in which the image quality of the toner image may be decreased, the print operation is executed in the “mixed productivity prioritized mode” according to the selection by a user. Therefore, for the user who wants to prioritize the productivity, it becomes possible to execute the mixed job by forcibly applying the mixed productivity prioritized mode even in the environment in which the mixed productivity prioritized mode cannot be applied, so that the productivity of the recording material is not decreased.

According to the present invention, upon executing the continuous image forming job, in which the recording material having different fixing temperatures corresponding to the basis weight are mixedly included, in the second mode in which the common temperature is used, in the case in which the image quality of the toner image may be decreased, it becomes possible to show the message and notify a user that the second mode is not applicable.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2024-129689 was filed on Aug. 6, 2024, which is hereby incorporated by reference herein in its entirety.

What is claimed is:

1. An image forming apparatus comprising:
an image forming unit configured to form a toner image on a recording material;
a fixing unit including a first rotatable member and a second rotatable member which forms a fixing nip for nipping and conveying the recording material by contacting the first rotatable member, and configured to fix the toner image onto the recording material by applying heat and pressure on the recording material on which the toner image is formed;
an executing portion configured to be capable of executing a continuous image forming job in which a first recording material of a first basis weight and a second recording material of a second basis weight are mixedly included, in either one of an operating mode of a first mode in which a fixing temperature which is a setting temperature of the first rotatable member is set to a first temperature in a case in which a basis weight of the recording material is the first basis weight and the setting temperature is set to a second temperature lower than the first temperature in a case in which the basis weight of the recording material is the second basis weight smaller than the first basis weight, and a second mode in which the setting temperature is set to a common temperature irrespective of the basis weight of the recording material;
an input portion configured to be capable of inputting either one of the operating mode of the first mode and the second mode;
a detecting portion configured to detect an inside temperature and an inside humidity in the image forming apparatus; and
a display portion configure to display that the second mode cannot be applied to the continuous image forming job in a case in which a condition that both the inside temperature and the inside humidity detected by the detecting portion are within a predetermined range is not satisfied when the second mode has been input to the input portion.

2. The image forming apparatus according to claim 1, wherein the executing portion does not execute the continuous image forming job until the condition is satisfied and executes the continuous image forming job in response to satisfaction of the condition.

3. The image forming apparatus according to claim 1, wherein the display portion displays that the second mode cannot be applied and displays so as to promote a user to switch to the first mode.

4. The image forming apparatus according to claim 3, wherein the executing portion stands by without starting the continuous image forming job until the first mode is input to the input portion in a case in which the condition is not satisfied before starting the continuous image forming job, and starts the continuous image forming job in the first mode in response to input of the first mode to the input portion.

5. The image forming apparatus according to claim 3, wherein the executing portion suspends the continuous image forming job until the first mode is input to the input portion in a case in which the condition is not satisfied during executing the continuous image forming job in the second mode, and restarts the continuous image forming job in the first mode in response to input of the first mode to the input portion.

6. The image forming apparatus according to claim 1, wherein the display portion displays that the second mode cannot be applied and displays so as to promote a user to select forcible execution of the continuous image forming job in the second mode.

7. The image forming apparatus according to claim 6, wherein the executing portion stands by without starting the continuous image forming job until the selection is made in a case in which the condition is not satisfied before starting the continuous image forming job, and starts the continuous image forming job in the second mode in response to the selection even when the condition is not satisfied.

8. The image forming apparatus according to claim 6, wherein the executing portion suspends the continuous image forming job until the selection is made in a case in which the condition is not satisfied during executing the continuous image forming job in the second mode, and restarts the continuous image forming job in the second mode in response to the selection.

9. The image forming apparatus according to claim 1, wherein when the continuous image forming job is executed in the second mode, the executing portion sets the second temperature as the common temperature in a case in which the continuous image forming job is a job in which a first number or more of sheets of the first recording material are not continuous and a second number or more of sheets of the second recording material are continuous following the first recording material.
